(19) United States
(12) Patent Application Publication
(10) Pub. No.: US 2006/0056313 A1
(43) Pub. Date: Mar. 16, 2006

(54) Method for automatic network integration of a network

(75) Inventor: Johannes Rietschel, Zurich (CH)

Correspondence Address: OBLON, SPIVAK, MCCLELLAND, MAIER & NEUSTADT, P.C., 1940 DUKE STREET, ALEXANDRIA, VA, 22314, US

(73) Assignee: BARIX AG, Zurich (CH)

(21) Appl. No.: 10/524,035

(22) PCT Filed: Aug. 13, 2003
(86) PCT No.: PCT/CH03/00544

§ 371 Date: Aug. 25, 2005

(30) Foreign Application Priority Data
Aug. 15, 2002 (CH) 140002

(51) Int. Cl. H04L 12/28; H04L 12/56

(52) U.S. Cl. 370/254; 370/389

(57) ABSTRACT

A method for automatically assigning an IP address when a new user is connected to a network. The new user monitors the network regarding at least one previously allocated valid IP address in a first phase while automatically creating an IP address that differs from the previously allocated IP address in a second phase, the address being only slightly modified, typically only the last byte thereof, the first three bytes being taken over from the previously allocated IP address that was found in the network. The availability of the newly created IP address is then verified by a request in the network, whereupon the new user assigns the IP address to him/herself if the newly created IP address is available, or the creation or verification of a new IP address is repeated if the IP address is not available.

### TECHNICAL FIELD

The invention relates to a method for automatically allocating an IP address when a new station is connected in a network, and to a network station which is able to carry out a method of this type automatically and also to a computer program for carrying out a method of this type.

### PRIOR ART

An IP address (Internet Protocol address) is a 32-bit number which identifies each sender or receiver of information transmitted in packets over the Internet or another TCP/IP network. An IP address has two parts, the first part representing a specific network on the Internet (net) and the second part representing a specific device, i.e. a server or a workstation (host). By way of example, a router requires only the first part of the IP address, which can be obtained by masking the address with a “netmask”, in order to forward the packets. In this context, there are different classes of such IP addresses, namely class A for large networks with a large number of network stations, class B for medium-sized networks, class C for small networks with fewer than 256 network stations, and class D, which is represented by “multicast addresses”. In the case of class A, the first bit is filled with 0, the specific network with the seven subsequent bits and the local address with the remaining 24 bits. In the case of class B, the first two bits are filled with 10, the next 14 bits represent the specific network and the remaining 16 bits are used for the local addresses (host). In a class C IP number, the first 3 bits are filled with 110, the next 21 bits represent the specific network and the last 8 bits represent the local address (hence no more than 256 network stations). The standard aforementioned split into “network” and “host” parts can be defined in any other manner by defining a “netmask”.

Typically, IP addresses are expressed in the form of four decimal numbers separated by dots, with each decimal number representing eight bits. The rapid increase in networks within the Internet means that it will probably be necessary to extend the IP addresses in the near future, and hence there is already a new version called IPv6 in which an IP address comprises 128 bits.

Generally, there are typically three different scenarios found in simpler TCP/IP networks:

a) Central management and possibly dynamic allocation of at least some IP addresses, normally via DHCP protocol or via BOOTP.

b) Static allocation of IP addresses by configuration (e.g. manual input)

c) Serverless, chaotic system by virtue of each device inventing an IP address in a defined network and checking it for double usage (“Auto IP”).

Variant a) is the typical configuration in company networks and in larger home networks, particularly when the networks are connected to the Internet via a cable or ADSL router with NAT (Network Address Translation). In this case, a dedicated server or a router normally undertakes the role of the DHCP server.

Variant b) is widespread in smaller networks, particularly when no special server has been installed—but also when, despite a DHCP server being present, it outputs only particular addresses to listed terminals. Variant b) is found a great deal in the home sector.

Variant c) is very rare at present, since most peripheral devices do not support Auto IP. However, it will be found when a number of PCs with a standard operating system are connected together in simple fashion WITHOUT a dedicated server and without a user who is familiar with IP.

Accordingly, particularly in the case of variant b), it is normally an extremely laborious matter to incorporate a new device in the network, since the network administrator, for example, first needs to learn what the network component of the IP addresses allocated in the network is called and what IP addresses are still available, if appropriate. Next, a free IP address of this type needs to be input manually. This is extremely difficult, particularly in the case of devices without a user interface (e.g. loudspeakers).

The problem of integrating a device into a radio network, (e.g. 802.11) is often even greater, since in this case a network identifier (SSID/BSID) and often also a network key need to be set in addition to the IP address. Particularly in environments in which a plurality of radio networks are operated, the known methods cannot currently be used to register a device without an explicit configuration in a particular network and to configure it for this network. The problem is particularly pronounced in the case of devices without a user interface, such as network loudspeakers. Such devices should have as few “buttons” as possible, not to mention keypads and displays, and should likewise be able to be incorporated into a network automatically, easily and without any great influencing action by the person installing it, where possible.

### ILLUSTRATION OF THE INVENTION

The invention is accordingly based on the object of providing a method which simplifies or automates the integration of a new network station in a network. The technical problem is thus that of avoiding the need for manual configuration of the new stations which have been connected.

This object is achieved in technical fashion by virtue of the network station added being autonomously able to allocate itself to an IP address without further influencing action by the person installing it. The subject matter of the present invention is accordingly a method in line with claim 1 or a device in line with claim 16.

The core of the invention thus involves the new station in the network allocating itself its IP number autonomously by virtue of the new network station monitoring the network for at least one already allocated valid IP number in a first phase, it generally being sufficient to monitor broadcasts sent to all network stations. In this context, the valid IP address taken is a sender address (a data packet contains the address of the receiver and that of the sender, of course). In a second phase, the new network station then independently, i.e. without any instructions from another computer, automatically generates an (i) IP number which is different than this already allocated IP number, with just the last byte being altered in this case, while the first three bytes are adopted from the already allocated IP number, and then the availability of this generated IP number is checked by means of a request in the network. If this generated IP number is available, the new station allocates it to itself, or, if it is not available, the generation of a new further IP number or the checking thereof is repeated. Such repetitions should remain within a sensible scope, however, so as not to cripple the network. In other words, by monitoring sender addresses of packets, the new network station intelligently establishes what type of network is involved and then generates a possible new IP address on the basis of this information and checks that it is not in use.

In line with a first preferred embodiment of the present invention, within the first phase during monitoring, sender IP numbers 0.0.0.0 are ignored and IP numbers in the range from 169.254.???.??? are logged. The former IP addresses are packets from stations without an IP address, and the latter IP addresses are IP addresses which are generated using Auto IP and which accordingly should be taken into account only when the network contains no other, actually valid IP addresses. The second phase is then initiated when the first different and hence valid IP number in the network has been monitored.

Preferably, the procedure in this case may be such that in principle a particular period (e.g. 3 minutes) is monitored and logged. Alternatively, it is possible to enter the second phase only when a first broadcast arrives and to log ARP (Address Resolution Protocol) requests, for example, but not to use them directly as a basis for generating a new address. This procedure then simplifies the rest of the action, since when a broadcast address is monitored in this phase already there is no need to determine the broadcast address as described further below in phase 3.

The new IP number generated on the basis of the IP address monitored in the network may be generated in different ways. Essentially, this involves modifying the address within the same network and then checking the availability of the selected address. By way of example, the last byte may be incremented or decremented by a fixed value, such as 1, the last byte may be filled with a random number, the last byte may be derived algorithmically from a system constant (e.g. MAC address or current time), or else this last byte may be assigned a fixed value (because typically only particular values are allocated).

The availability of the generated IP number can be obtained using an address resolution request (address resolution protocol request, ARP request) with the generated IP number, the generated IP number being assumed to be available if there is no response or being assumed to be unavailable if a response is received.

Typically, the inventive method is used only when there is no automatic and possibly dynamic allocation of IP addresses available in the network (that is to say not in situation (a) as described above). Accordingly, a check is preferably first carried out to determine whether the network contains a server for automatically, possibly dynamically, allocating IP numbers, (e.g. DHCP or BOOTP), and if there is such a server the new station assigns itself the IP number allocated by this server. The inventive method is used only if such automatic allocation is not available in the network.

If no valid IP number is received in the first phase within a characteristic time of, typically, in the range of three minutes then automatic allocation can be performed using Auto IP, taking into account IP numbers in the range from 169.254.???.??? which may have been logged and are thus obviously already in use in the network, i.e. numbers generated by Auto IP.

Another preferred embodiment of the present invention is distinguished in that the new station is a station with an audio output, and in that the finally assigned IP number is output via this audio output. This outputting is found to be advantageous particularly when the station is a terminal which does not have input options. Regardless of the method for determining the IP address, the inventive concept (which is also independent of the aforementioned special method of allocating IP addresses) of immediately outputting a newly assigned IP address via an audio output is found to be extremely practical and beneficial. Even when DHCP, for example, is available in a network and the new station is assigned an IP address externally in this manner, or when, by way of example, another device also assigns the new station an IP address following manual input, it is frequently necessary to know this assigned IP address for a wide variety of reasons. If the new network station is, by way of example, a streamer or network loudspeaker for outputting music which is at least partly loaded via the network or is at least controlled, or spoken messages, then a streamer of this type frequently does not have a keypad for inputting an IP number and also does not have a display for showing an IP number once it has been assigned. Accordingly, particularly in a situation of this type, it may be extremely advantageous to provide the option of outputting the number automatically, for example using a voice synthesizer integrated in the device.

A further improvement to the proposed method can be achieved by virtue of the assignment of the IP number being followed by automatic determination of broadcast address and netmask. This is primarily necessary when the new network station needs to look for a communication partner (e.g. server) by broadcast. Usually, the valid broadcast address can easily be ascertained from the data packets monitored in phase 1, since normally only broadcast addresses or multicast addresses are feasible as a receiver address for such packets. If the broadcast address nevertheless needs to be determined, then this can be done, for example, by first using the first three bytes (firstly assuming a simple class C network) of the allocated valid IP number from the network to check all possible broadcast addresses from the bottom upward with a query about protocols, such as ping. In this case, the check is performed in a manner such that the bits of the IP number are filled to some extent with ones from the right, namely the first 8 bits from the right (00000001, 00000011, 00000111, 00001111 etc., simple class C network). If no broadcast address is found in this way, then a larger, compiled class C network may be involved, or else a class B or a class A network (this can be derived from the first bits of the address). Accordingly, the bits which are furthest back are successively checked in similar fashion for possible broadcast addresses by filling with 1 from the right. The valid broadcast address taken is the first IP number to which any stations in the network which have a lower IP number respond. The netmask is then stipulated such that the network bits above the broadcast component are set to 1 and all bits of the broadcast component are set to 0.

Since an automatic and autonomous method sometimes involves IP addresses being allocated which are firmly assigned to a device which is not situated on the network at the time of assignment (e.g. a printer or computer which is switched off), and accordingly instances of double usage may arise upon later connection of such a device, it should be periodically checked whether the assigned IP address is actually still available. Accordingly, after the IP number has been allocated as mentioned, periodic requests should be used to check the network to determine whether the IP number of the new station is still unique, and if a further station with the same IP number is found then a free and valid IP number should be sought, checked and allocated by re-entering the second phase. Similarly, the maybe only temporarily disrupted availability of an automatic configuration server (DHCP, Bootp) should be repeatedly checked cyclically, and if one is available then an address should be requested from it.

In line with a further preferred embodiment of the inventive method, at least one network station already integrated in the network executes a program which sends data packets in the form of markers in order to indicate to the new station what network it needs to integrate itself in. This program may be supplied by the manufacturer of a new device, for example on a CD, and may be started automatically following the insertion of such a CD so as to keep the knowledge and experience which the station requires to a minimum. This method is appropriate particularly when, for example in a cable-based network, a plurality of different IP domains are active, since otherwise the new network station may be integrated into the wrong network. This procedure is particularly important when radio networks are involved, since these are difficult to separate from one another and the radio network from a neighboring office or building, for example, may very often be present and also accessible. It should be noted that this transmission of markers is an invention independently of the subsequent stipulation of the IP address by the new station, as described in the independent claim.

If the radio network is an unencrypted cable-based network, then the markers may be data packets whose contents clearly address the new station directly. However, if it is a radio network which, on account of the aforementioned poor separation of said radio networks from one another, is normally often operated on an encrypted basis, then such direct addressing of the new station is not possible. In this case, to indicate to the new station what channel it needs to integrate itself on, markers can be sent in coded form on the network. Such coding may involve, by way of example, sending data packets of specific and identifiable block length and/or at specific and identifiable time intervals, since such rules can be identified by the new station regardless of the encryption. The station can thus use monitoring to establish what channel it needs to integrate itself on.

In line with a further preferred embodiment, the markers are used to transfer network parameters to the new station directly or indirectly, preferably using a coding (packet length or spacing thereof). Thus, by way of example, this coded transmission method may be used to send details such as SSID/BSID, or else the IP address for allocation and particularly also the applicable network key, to the new station. With particular preference, the new station then preferably has the security and reliability of the data transmission verified using appropriate control mechanisms (cyclic repetition, checksum etc.). The security gap associated with the transfer of markers into a network should be minimized by virtue of the new station, following successful registration thereof in the network, acknowledging its registration to the network station which is already integrated in the network and then the program on the network station which is already integrated in the network being automatically stopped.

Particularly when a plurality of new stations are to be integrated in the network simultaneously, it is found to be advantageous to send the markers on the basis of an identification number which is specific to the new station, such as on the basis of its MAC address. Particularly when an encrypted network is involved, it is recommended that the security gap associated with the sending of markers which contain information about the network key be kept as small as possible. This can be achieved by virtue of the markers, for their part, being encrypted information, in which case the key, for example, can be derived from a specific identification number, such as the MAC address of the new station. A simple “transport key” which is known to the marker-sending software and also to the as yet unconfigured device as soon as it leaves the factory also increases security a great deal.

As already mentioned at the outset, the present invention also relates to a network station for connection to a network. This network station comprises at least one communication interface for interchanging data with the network, at least one storage medium and at least one processor (CPU) which is connected to this interface and to the storage medium, the storage medium containing programs for execution by the processor. In line with the invention, the storage medium (RAM or ROM, hard disk) in this case stores a program for carrying out the method for automatic and autonomous IP address allocation, as described above. Advantageously, the network station automatically activates this program after connection to a network, provided that it has not yet been activated. In addition, the network station preferably has an audio output via which an assigned IP number is output.

The invention also relates to a computer program for carrying out a method as described above or for storage in a network station as described above.

Further preferred embodiments of the present invention are described in the dependent claims.

### BRIEF EXPLANATION OF THE FIGURE

The invention will be explained in more detail below using exemplary embodiments in connection with the drawing. The single FIGURE shows a flowchart of the inventive method for assigning IP numbers.

### WAYS OF IMPLEMENTING THE INVENTION

The invention allows the use of networkable devices in networks of variant b) described at the outset (without a DHCP server—or with a DHCP server which has a fixed configuration) WITHOUT the need for the devices to be actively assigned a fixed IP address. This is of particular advantage for devices which have no control facility (display/keypad)—that is to say are thus configurable only by network. By way of example, devices such as audio streamers are suitable for this purpose, these being able to reproduce music which is loaded over the Internet or is at least partly controlled.

The invention is compatible with the known methods of automatic configuration (DHCP, Auto IP) and does not adversely affect the use of a device which is equipped with it in standard networks. To some extent, the method closes the gap between a network with DHCP and a network without any structured allocation of IP numbers (typically a network with Auto IP).

Normally, a device which has had no static IP address set for it (e.g. a freshly delivered device which is to be integrated into a network for the first time) will first of all search for a DHCP server. If no response is recorded from a server within a particular period of time, devices in which Auto IP is implemented involve the use of Auto IP to generate an IP address in a particular, stipulated network (IP network class B, 169.254.x.x, i.e. numbers in the range from 169.254.1.0 to 169.254.255.254), using a random number generator after waiting for this time and to check that this address is not present. If it is established that the address is already in use (test using an ARP packet, for example), a new address is generated in the defined range and is checked again.

The action continues until a free “Auto IP” address is found or a particular maximum number of attempts has been made. An IP address of this type does not permit any direct communication with the outside, however.

The invention is now used between the search for a DHCP server and the Auto IP address generation (if actually implemented).

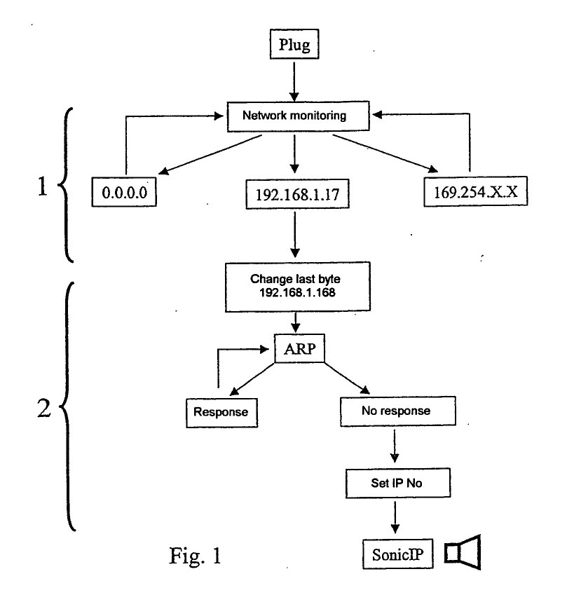

The method is shown schematically in the form of a flowchart in FIG. 1 and will be explained in words below:

Phase 1 (cf. Curly Brackets in FIG. 1):

If possible, when the system is actually started, before the end of the search for a DHCP server, a handler for received blocks from the network is installed which should receive all broadcasts, multicasts and ARP requests from the network if at all possible. However, the latest time at which this handler should be installed is the start of the phase of detecting IP addresses which are already present in the network.

This handler is of very simple design. In each block which arrives, the source IP address is checked (it is present in every IP block, be it a broadcast or multicast, and ARP blocks likewise contain the source IP address) to determine whether it is a valid address (not 0.0.0.0, not 255.255.255.255). If it is an Auto IP address (169.254.x.x), this is noted and the search continues.

As soon as the first block with a valid IP source address not equal to Auto IP has been received or a particular time (approximately 3 minutes is appropriate) has elapsed, the handler can be uninstalled again. If this is not technically possible it is deactivated.

If no addresses or just Auto IP addresses have been received within the search period, the algorithm is aborted and Standard Auto IP is activated.

If a valid IP source address has been received within the search period (not equal to Auto IP), phase 2 is started.

Phase 2:

The valid IP source address received is now examined and processed as follows:

The last byte of the IP address is set to a different value, there being various possible tactics in this case. The generated address naturally needs to be valid, and to ensure this as far as possible the 0 must not and the 255 should not be used. Possible tactics are (incomplete list):
a) the “next” address (original value +1)
b) a random number
c) a number derived algorithmically from a system constant (e.g. MAC address or time)
d) a fixed value, e.g. 168 (IP addresses with, by way of example, the last position 0.168 are statically underrepresented in smaller networks, 1, 2, 3, 10, 11, 100, 200, 254 being much more frequent)

The selected address (the first three bytes are the ones monitored) is now checked using an ARP search (as far as possible 2× at a short interval of time to increase security) to determine whether it is not already in use. If so, a new address is generated by increasing it by an increment, by new random number generation or by again algorithmically taking into account the information that a new attempt is being made.

The number of attempts should be limited to a sensible value (e.g. 32×).

If the address is not in use, it is set as the IP address of the device.

Depending on the application, it may now still be important to detect the “netmask” and hence indirectly the “broadcast” address.

This is done in Phase 3, which is optional (depending on the application): a datagram is sent to a generally available port (e.g. ICMP echo request) using a hardware broadcast, with the received source IP address being filled with “1” bits from the right little by little. If the broadcast address is “hit”, devices will respond to the query, but with their private IP address as sender, and this is then not the same as the selected possible broadcast address tested. The netmask can now easily be derived from the number of “1” bits.

If the station which has been newly integrated into the network, which station is a computer at least having a CPU, a memory (RAM and/or ROM and/or hard disk) and also having at least one interface to the network, has found a valid and available IP address, then the new station will automatically assign itself this address. Particularly if it is a device which does not have a keypad and/or a screen, it may then prove to be extremely practical, following the assignment, if, by way of example, a loudspeaker and voice production software (which stations likewise contain) are used to output the finally assigned IP number over this loudspeaker. If a music streamer which can be addressed over the Internet is connected as a new device, for example, then it is crucial to have its IP address available for the subsequent actuation. Accordingly, this address should be made known following connection. It is naturally also possible to provide a music streamer of this type with a piece of software which sends the definitively set IP address to a server immediately after generation and assignment, said server then identifying the device's serial number and being able to address said device directly.

The following is a specific example of the overall method:

Phase 1: Device waits for incoming blocks:
Block 1—IP broadcast from address 0.0.0.0—
   Invalid address, ignore
Block 2—IP broadcast from address 169.254.17.13—
   Auto IP address, record but continue searching
Block 3—ARP request from IP 192.168.1.17—
   Valid IP address, therefore terminate phase 1.

Phase 2: Check whether just Auto IP address has been received—
Result negative, therefore carry out phase 2.
Address generation—e.g. following algorithm d). Test address is now 192.168.1.168
Check address 192.168.1.168 for availability. If not available, define new address according to methods described and repeat check. In the example, it is assumed that the address is free.
Result: IP address 192.168.1.168 is adopted as the IP address of the device.
Option: automatic output of this IP address over a loudspeaker.

Phase 3: Establish the broadcast address/netmask.
It has already been identified from the 1st byte that a class C network must be involved, i.e. only the last byte needs to be examined for possible broadcast addresses.
Send a ping via hardware broadcast to IP address 192.168.1.3 (minimum possible size of an IP network, the last byte corresponds to binary 00000011)
Result: response from device 192.168.1.3
Send a ping via hardware broadcast to IP 192.168.1.7 (the last byte corresponds to binary 00000111)
Result: no response
Send a ping via hardware broadcast to IP 192.168.1.15 (the last byte corresponds to binary 00001111)
Result: no response or response from device 192.168.1.15
. . .
Send a ping via hardware broadcast to IP 192.168.1.255 (the last byte corresponds to binary 11111111)
Result: response from device 192.168.1.1, 192.168.1.2, 192.168.1.3, 192.168.1.17. Obviously, the checked address is the broadcast address (devices with a “different”, lower IP address than the one checked respond).
Result: 192.168.1.255 is the broadcast address, 255.255.255.0 is the netmask.
Option: automatic output of this IP address over a loudspeaker.

If a plurality of networks are active on one network (e.g. various IP address ranges next to one another) or particularly if a wireless network is involved which can even be encrypted, then this network can nevertheless be used for data transmission anyway, even if it operates on an encrypted basis, so long as at least one device which is already integrated in the network can be used to access the network. This can be done by coding the information which is to be sent to the new station (what network, network parameters). This information is sent in the form of markers on the network and can be monitored by the new, as yet unintegrated station.

By way of example, two “coding methods” are conceivable for these markers:

a) Send data about the block length (even if the content is encrypted, the length of the block can be detected at least roughly in the case of normal encryption methods, even without knowledge of the key).

b) Send data about a time coding, e.g. send a data block every 50 ms, omission of the block (or generating a second block shortly after the first block) can be used for transmitting information to the station which is to be integrated.

Naturally, other data are also sent on the network, which means that the “receiver” (i.e. the monitoring new station) needs to synchronize itself to the sender's time frame, which needs to be known, and the security of the data transmission should be ensured through cyclic repetition/CRC and/or checksums.

Using this procedure, the “preliminary phase” of identifying the correct network and sending the network parameters (SSID/BSID/key etc.) can then be resolved as follows, for example:

I) Identification

I.1) A device with transmission authorization which is connected to the network on which the new device is intended to be registered has a program started on it which sends data blocks of fixed or variable length and no significant content in a stipulated time frame.

I.2) A device which is intended to be registered on a network (for example because it is still unconfigured or cannot log onto any existing network with the stored network configuration) checks all existing networks for the occurrence of a regular pattern of this type which occurs in the fixed time frame. If a marker of this type is identified over a certain time (with possible errors when there is a full load on the network), then it can be assumed with very high probability that the correct network has been found.

II) Transmission of the Network Parameters

II.1) If keys are needed or if network parameters need to be sent (SSID/BSID, or else IP address and the like), this information is input into the “transmission program” I.1) or is ascertained automatically thereby from the network configuration. These data are then sent bit by bit using time-coded and/or length-coded blocks on the network and can be monitored by the new, as yet unintegrated station (“broadcasting”).

II.2) The device to be configured, which has already identified the network in step I), adopts the coded data from the transmitted blocks, checks the checksum/CRC, if available (or receives the message a plurality of times), and then uses these parameters as a basis for configuration or for automatic registration in the network.

In this context, the following variants are usefully conceivable:

a) The device which has been configured in this manner can, if the IP/sender address of the “broadcaster” is also indicated in the coded data stream, “report back” to said broadcaster when registration has taken place and can thus provide the user with clear feedback to the effect that the configuration was successful. This feedback should automatically result in the program which had been started on the computer already integrated in the network beforehand for the purpose of sending the markers being automatically stopped in order to keep the security gap which a program of this type usually entails open for as short a time as possible.

b) By adding the MAC address of the “destination device”, for example, it is possible to ensure that only precisely one device is configured—which is required, for example, when the IP address or other addresses which are unique in the network are also intended to be transmitted using the method described, or in order to permit simultaneous problem-free integration of a plurality of new stations.

c) The information sent can be encrypted prior to transmission, with it merely being necessary for the “broadcast” program and the device which is to be configured to know the same key. This key can be derived from the device's MAC address, for example, which then automatically results in b).

1-17. (canceled)

18. A method for automatically allocating an IP address when a new station is connected in a network, comprising:
in a first phase, the new station in the network allocating itself its IP address autonomously by virtue of the network being monitored for at least one already allocated valid IP address; and
in a second phase, an
(i) IP address that is different than the already allocated IP number is generated automatically, with generation involving the IP address being altered only slightly,
(ii) availability of the generated IP address is checked by a request in the network; and
if the generated IP address is available, the new station allocating it to itself or, if it is not available, the generation of a new IP address (i) or the checking thereof (ii) being repeated.

19. The method as claimed in claim 18, wherein in the second phase (i) the address is altered by altering just a last of four bytes, while first three bytes are adapted from the already allocated IP address.

20. The method as claimed in claim 18, wherein within the first phase during monitoring, IP addresses at 0.0.0.0 or 255.255.255.255 are ignored and IP addresses in a range from 169.254.1.0 to 169.254.254.255 are logged, and wherein the second phase is initiated when the first different and hence valid IP address in the network has been monitored.

21. The method as claimed in claim 18, wherein the automatically generated IP address is either by virtue of a last byte being incremented or decremented by a fixed value, by virtue of the last byte being filled with a random number, by virtue of the last byte being derived algorithmically from a system constant or by virtue of it being assigned a fixed value.

22. The method as claimed in claim 18, wherein the availability of the generated IP address is obtained using an address resolution request with the generated IP address, and by virtue of the generated IP address being assumed to be available if there is no response or being assumed to be unavailable if a response is received.

23. The method as claimed in claim 18, wherein a check is first carried out to determine whether the network contains a server for automatically allocating IP addresses, and wherein if there is such a server the new station assigns itself the IP address allocated by the server.

24. The method as claimed in claim 18, wherein if no valid IP address is received in the first phase within a characteristic time, then automatic allocation is performed using Auto IP.

25. The method as claimed in claim 18, wherein the new station is a station with an audio output, and wherein the finally allocated IP address is output via the audio output.

26. The method as claimed in claim 18, wherein the assignment of the IP address is followed by automatic determination of broadcast address and netmask, the procedure being that a destination address of a monitored broadcast block is adopted as broadcast address.

27. The method as claimed in claim 26, wherein the broadcast address is determined by using first three bytes of the allocated valid IP address from the network to check all possible broadcast addresses from the bottom upward with a query about protocols, and the valid broadcast address taken being the first IP address to which all stations in the network that have a lower IP address respond, and by then stipulating the netmask such that all bits above the broadcast component are set to 1 and all bits of the broadcast component are set to 0.

28. The method as claimed in claim 18, wherein after the IP address has been allocated, periodic requests are used to check the network to determine whether the IP address of the new station is still unique, and wherein if a further station with the same IP address is found then a free and valid IP address is sought and allocated by re-entering the second phase.

29. The method as claimed in claim 18, wherein at least one network station already integrated in the network executes a program that sends data packets in a form of markers to indicate to the new station what network it needs to integrate itself in.

30. The method as claimed in claim 29, wherein the markers are data packets of specific and identifiable block length and/or at specific and identifiable time intervals, the network being a cableless network.

31. The method as claimed in claim 29, wherein the markers are used to transfer network parameters to the new station directly or indirectly, using coding, in which case the new station has security and reliability of the data transmission verified using appropriate control mechanisms, and where the new station, following registration thereof in the network, also acknowledges its successful registration to the network station that is already integrated in the network and then the program on the network station that is already integrated in the network is automatically stopped.

32. The method as claimed in claim 29, wherein the markers are sent on based on an identification number that is specific to the new station.

33. The method as claimed in claim 29, wherein the markers are encrypted information, with the key being derived from a specific identification number.

34. A network station for connection to a network comprising:
at least one communication interface configured to interchange data with the network;
at least one storage medium, and a processor connected to the interference and to the storage medium, the storage medium containing programs for execution by the processor,
wherein the storage medium contains a program for carrying out the method as claimed in claim 18, and wherein the network station automatically starts the program after connection to a network, provided that it has not yet been activated, and wherein the network station has an audio output and can output an allocated IP number via this audio output.

35. A computer program for carrying out a method as claimed in claim 18.
